(19) United States
(12) Patent Application Publication
(10) Pub. No.: US 2019/0118367 A1
(43) Pub. Date: Apr. 25, 2019

(54) LIGHTWEIGHT GRIP

(71) Applicant: Eaton Intelligent Power Limited, Dublin (IE)

(72) Inventor: STEPHEN JAMES DAVIS, PINEHURST, NC (US)

(21) Appl. No.: 16/126,265

(22) Filed: Sep. 10, 2018

Related U.S. Application Data
(60) Provisional application No. 62/575,564, filed on Oct. 23, 2017.

(51) Int. Cl. B25G 1/10; A63B 53/14; A63B 49/08; A63B 60/54; A63B 60/50

(52) U.S. Cl. CPC B25G 1/102; A63B 53/14; A63B 2209/00; A63B 60/54; A63B 60/50; A63B 49/08

(57) ABSTRACT

A lightweight flexible grip for a shock imparting implement having a plurality of through the wall cavities. The through the wall cavities may have any shape or form and be located in any desired arrangement and location on the grip. The present disclosure is particularly suited as a hand grip for a sporting implement like a lightweight golf club grip having good traction, comfort, and hand feel.

### CROSS-REFERENCE TO RELATED APPLICATIONS

This application claims priority to co-pending application U.S. Ser. No. 62/575,564, filed Oct. 23, 2017, in the name of Stephen James Davis for a “Lightweight Grip”, which is incorporated by reference herein in its entirety.

### BACKGROUND

The present disclosure relates in general to hand grips, and more particularly to lightweight grips of the type employed with shock imparting implements, for example, golf clubs, tennis racquets, or similar sport implements, or other types of shock imparting implements such as, for example, hammers or axes. The present disclosure may be employed in any application that requires a hand grip including without limitation motorcycles, all-terrain vehicles, jet skis, or personal watercrafts.

Such grips are typically formed of molded rubber or an elastomer in tubular form with one substantially closed end and an opposite open end. The open end receives the handle or shaft of the shock imparting implement. The handle or shaft may have a tubular configuration or be formed of a solid material such as metal or a composite or even wood. Typically, the grip is formed of a material having a relative hardness sufficient to facilitate gripping by the user for its intended use, for example, during swinging when employed on a sports implement like a golf club. It is also desirable for the grip to have a good hand and grip feel so as not to be too hard.

Golf grips are typically made from rubber, an elastomer, or thermoplastic material, or combinations of these materials. Current designs use a texture or dimples to provide traction and comfort. In achieving this comfort factor, the grips are formed with a thickness to sufficiently yield a compliant or pliable soft flexible surface for the user's hand. This can require an amount of material that adds weight to the implement and a resultant increase in cost for the material.

Thus, it has been desired to provide a lightweight grip such as a flexible golf club grip with good traction and comfort that does not require excess material, and particularly such a grip that may be injection or compression molded as a one piece to be assembled over the implement handle or shaft.

### BRIEF DESCRIPTION

The present disclosure describes a lightweight flexible grip for an implement, particularly a flexible golf club grip of the type which may be molded of elastomeric material as a unitary or one-piece member to be assembled over the shaft of the golf club. In one version, the flexible grip of the present disclosure has a plurality of through the wall cavities selectively arranged in the flexible grip.

In another version, the through the wall cavities have selected shapes for the through the wall cavities to provide desired shock absorption and comfort in selected portions of the grip.

In another version, the through the wall cavities may vary in size and shape and location on the grip. For example, the through the wall cavities may be larger or of a different shape in one region of the grip than another region for providing more cushioning or comfort, or alternatively traction, or both.

The various features of novelty which characterize the present disclosure are pointed out with particularity in the claims annexed to and forming a part of this disclosure. For a better understanding and its operating advantages attained with its use, reference is made to the accompanying drawings, and descriptive matter.

### BRIEF DESCRIPTION OF THE DRAWINGS

FIG. 1 is a sectional view of the lightweight grip of the present disclosure on a portion of a shaft;

FIG. 2 is a sectional view taken along section indicating lines 2-2 of FIG. 1;

FIG. 3 is a front elevational view of a golf grip in accordance with the present disclosure showing an arrangement of the through the wall plurality of cavities which may be used for hand placement;

FIG. 4 is a partial sectional view of another version of the present disclosure taken along lines 4-4;

FIG. 5 is a view similar to FIG. 4 depicting yet another version of the present disclosure;

### DETAILED DESCRIPTION

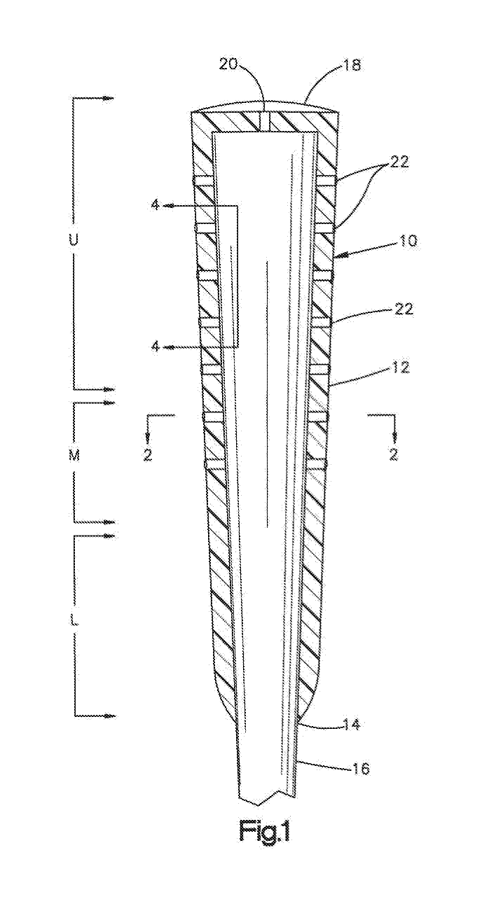

Referring to the Figures which are not intended to limit the present disclosure and where like numerals designate like or similar features throughout the several views, and first in particular to FIG. 1, there is shown one version of the lightweight flexible grip of the present disclosure generally designated as 10. Grip 10 is an elongated flexible tubular member 12 formed of an elastomeric, rubber, or thermoplastic material, or combinations thereof, and has an open end 14 to a hollow interior which is adapted to have received therein a handle or shaft 16 of an implement, such as a shock imparting implement as an example, which in the illustrated version of the Figures comprises a tubular shaft for a golf club. It should be understood that the present disclosure finds application to any hand grip and should not be limited to just golf club grips. The grip 10 has a substantially closed end 18 opposite the open end 14 referred to herein as the butt end of the grip. The butt end 18 has an aperture 20 provided therein for facilitating assembly of the grip 10 onto the shaft 16 and permitting air to flow or circulate therethrough.

The butt end 18 may be formed integrally as one-piece with the tubular member 12, and being made from the same material as the tubular member 12 by injection or compression molding the butt end 18 simultaneously therewith. Alternatively, the butt end 18 may be formed of a different thermoplastic, elastomer or rubber material having different physical properties or color; and, the butt end 18 attached to the end of the tubular member 12 in any manner known in the art.

A plurality of cavities 22 that pass through the wall of tubular member 12 are arranged in any desired pattern, and situated in any specific location, region or regions, for example, regions U, M, L on the tubular member 12. The upper region of the grip is labeled U, the middle region labeled M, and the lower region L. Through the wall cavities 22 as that term is used herein is meant to include without limitation a hole or a groove or an indentation or cut that passes completely through the wall of the tubular member 12 and terminates at the shaft or handle 16. The plurality of through the wall cavities reduce the weight of the grip more than dimples or other indentations which have a floor and do not penetrate the wall of the grip to the shaft or handle. In addition, the through the wall cavities 22 may provide more cushioning than dimples, allowing more displacement of the rubber or elastomer material of the grip from impact loads when imparting shock. The through the wall cavities 22 allow the surface of the shaft 16 under the grip 10 to be visible for monitoring wear of the grip 10 as well as wicking away moisture. As will be described in greater detail, the through the wall cavities 22 may vary in size, shape, location, and spacing or distance between the through the wall cavities 22.

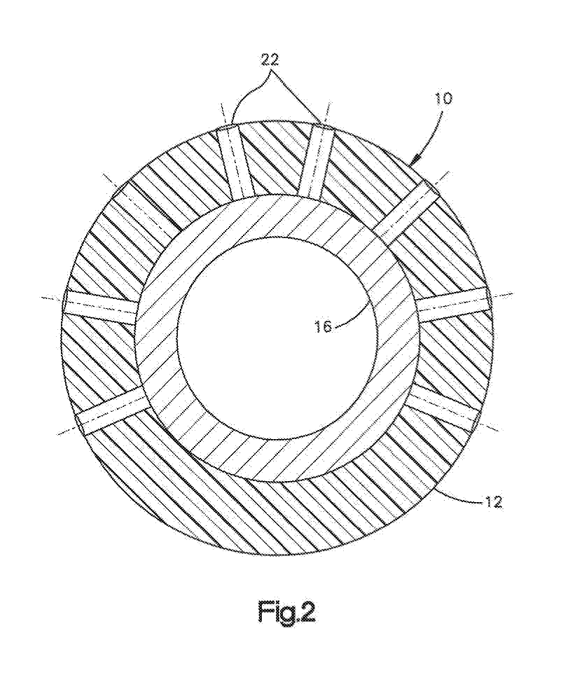

In FIGS. 1 and 2 the through the wall cavities 22 are circular shaped holes, but in other versions the through the wall cavities 22 may be oval, triangular, orthogonal, square or venturi or hourglass shaped, or grooves or cuts, and one or more can vary in diameter, width, size, shape, or location on the grip 10. In FIG. 1, the through the wall cavities 22 are situated primarily in the upper region or end labeled as U on grip 10 with a few of the plurality of through the wall cavities 22 extending further into the mid-region or section labeled as M on grip 10. If desired some of the through the wall cavities 22 may extend even further into the lower region of the grip 10 in the region labeled L for the lower region. Cavities 22 may be placed as desired all along the body of the grip 10 or only on one side of the grip, or even only on one side in one region of the grip for optimizing grip weight and feel.

Turning next to FIG. 2, specific locations on grip 10 may contain the plurality of through the wall cavities 22. In this embodiment the plurality of through the wall cavities 22 only extend around a specific portion and location of grip 10, and can serve another purpose such as a guide for hand positioning or in the form of a decoration or indicia or symbol or word(s) for example, like, an alma mater or team. That portion may include around the entire grip or only a portion of the grip (a half, a quarter, a tenth, etc.) in any given location on the grip. It can include a highlighting color(s). In other embodiments, the plurality of through the wall cavities 22 may extend completely around the entire grip or in select portions or locations of the grips in specific regions U, M, or L. In FIGS. 1 and 2, each of the plurality of through the wall cavities 22 have a substantially constant diameter giving each through the wall cavity a cylindrical shape. The through the wall cavities 22 do not all have to have the same shape or diameter. The plurality of cavities 22 may consist of some grooves, some through holes, some through the wall cavities of an orthogonal shape or other forms. The plurality of through the wall cavities 22 may have any desired shape and be formed structurally in many different ways through any known process including injection, compression, or other molding processes.

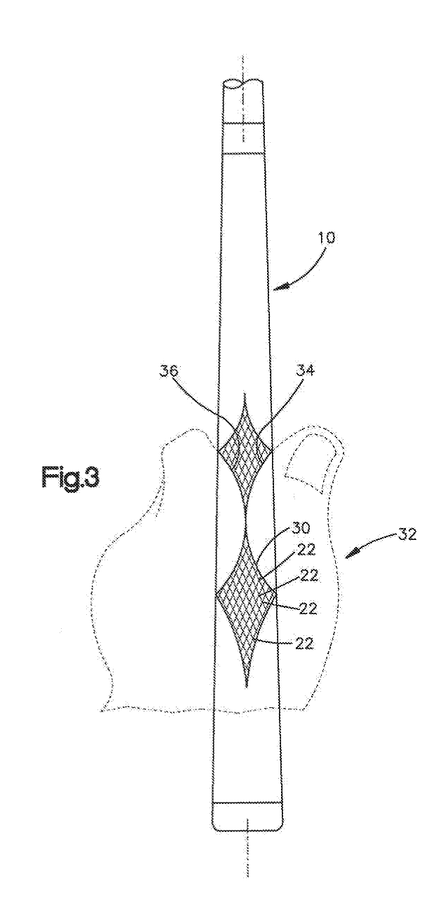

Referring to FIG. 3, the present disclosure may be used not only for providing a lightweight grip, but also as an indicator for a user for hand placement. The pattern or a set arrangement 30, such as the joining diamond shaped arrangements, with the plurality of through the wall cavities 22 on grip 10 in FIG. 3 may act as a guide for proper hand placement 32 as seen by the illustrated hand in phantom line. The arrangement 30 may have a boundaries 34, 36 which may function as a guide as depicted in FIG. 3. An inner edge of the golfer's thumb is placed along the curvature 34 on one side of the arrangement 30 and an inner edge of the index finger along the opposite curvature side 36 when grasping the golf club grip firmly with the fingers of the hand. In this embodiment, each of the plurality of through the wall cavities has a diamond shape and extend along substantially the front surface of grip 10. As in the other versions each of the diamond shaped cavities 22 are through the wall cavities 22. In still other embodiments (not shown), the through the wall cavities 22 may be combined with other etches or grooves or designs that do not exit through the wall.

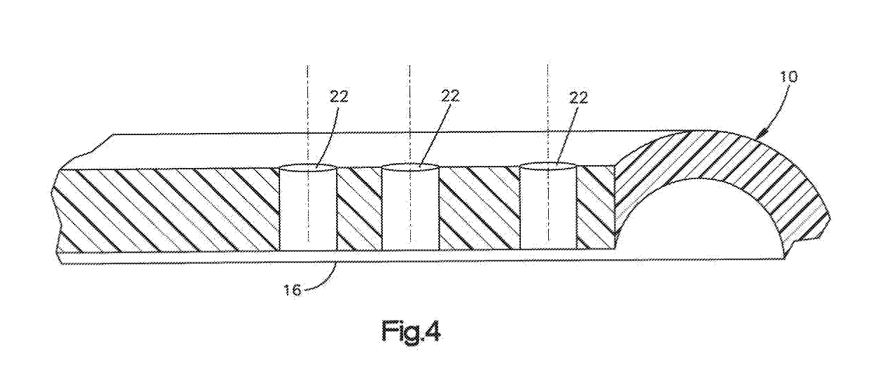

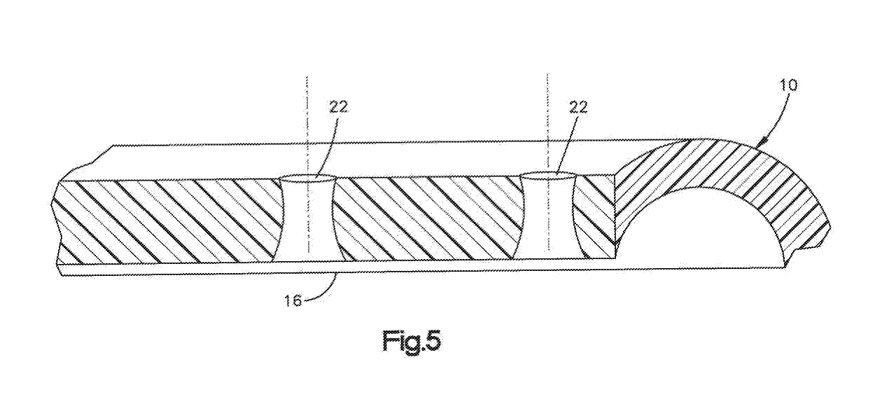

As seen in FIG. 4, the through the wall cavities 22 may take the form of a circular hole cut through the wall of the grip 10 in any desired arrangement, location, or region. The circular holes 22 may have the same diameter d, or different diameters as desired. The circular holes 22 have a depth right down to the shaft 16. A second cover material (not shown) may be included over the grip 10 and consist of a second type of material different from the rest of the tubular material of the grip 10. The use of a second material can offer benefits such as a more comfortable feel for a softer grip, or alternatively a harder feel with a more supportive grip feel. In FIG. 5, the through the wall cavities 22 may have a form, like an hourglass, which may offer more shock absorption. As is immediately apparent from the several Figures, the through the wall cavities may be of any shape or form and may be located in desired arrangements, spacings, and regions on the grip.

The present disclosure thus describes a lightweight flexible grip for an implement such as a golf club wherein the grip has a tubular member with an open end adapted to have the end of the implement handle received therein such as the tubular shaft of a golf club. The open end of the grip has an opposite substantially closed end, which may be formed of a different elastomeric or rubber material and may be of a different hardness. A plurality of through the wall cavities selectively spaced and located situated in the tubular member can provide traction, comfort, shock absorption, and a lighter weight grip. The cavities 22 may be formed by injection molding, compression molding, or other molding processes.

The exemplary versions have been described with reference to the drawings. Obviously, modifications and alterations will occur to others upon reading and understanding the preceding detailed description. It is intended that the exemplary versions be construed as including all such modifications and alterations insofar as they come within the scope of the appended claims or the equivalents thereof.

1. A grip for a shock imparting implement, comprising:
a flexible tubular member having an open end operative for receiving therein an implement shaft and a substantially closed end opposite the open end; and
a plurality of through the wall cavities selectively spaced in said flexible tubular member.

2. The grip according to claim 1, wherein the open end is configured for receiving therein a golf club shaft.

3. The grip according to claim 2, wherein at least one of the plurality of through the wall cavities has a circular shape.

4. The grip according to claim 2, wherein at least one of the plurality of through the wall cavities has a cylindrical form.

5. The grip according to claim 2, wherein the plurality of through the wall cavities are selectively spaced in a set arrangement on at least one of selected regions of the grip.

6. The grip according to claim 5, wherein the at least one selected region is situated at an upper end of the grip and circumferentially around the upper end of the grip.

7. The grip according to claim 5, wherein the at least one selected region is situated on one side at an upper end of the grip.

8. The grip according to claim 1, wherein at least one of the plurality of through the wall cavities has a venturi shape.

9. The grip according to claim 1, wherein at least one of the plurality of through the wall cavities has a diameter different from at least one of the other plurality of through the wall cavities.

10. The grip according to claim 1, wherein at least one of the plurality of through the wall cavities varies in size.

11. The grip according to claim 2, wherein at least one of the plurality of through the wall cavities varies in shape.

12. The grip according to claim 5, wherein at least one of the plurality of through the wall cavities is a groove.

13. The grip according to claim 12, wherein the grip further includes decorative coloring.

14. The grip according to claim 13, wherein the set arrangement comprises an indicator for hand placement on the grip.

15. The grip according to claim 5, wherein the grip comprises at least two different materials with said plurality of through the wall cavities being situated only in one of the two materials.
